(19) United States
(12) Patent Application Publication
(10) Pub. No.: US 2020/0139465 A2
(43) Pub. Date: May 7, 2020

(54) COUPLING DEVICE

(71) Applicants: Michel HULSEBOS, Holten (NL); Arjen Cornelis van der Molen, Heerde (NL)

(72) Inventors: Michel HULSEBOS, Holten (NL); Arjen Cornelis van der Molen, Heerde (NL)

(73) Assignee: Georg Fischer WAGA N.V., Epe (NL)

(21) Appl. No.: 16/189,652

(22) Filed: Nov. 13, 2018

(30) Foreign Application Priority Data
Nov. 16, 2017 (NL) N2019920

(51) Int. Cl. B23H 9/14; B23H 1/02

(52) U.S. Cl. CPC B23H 9/14; F16L 21/08; B23H 1/02

(57) ABSTRACT

Coupling device (1) for a pipe (2), including a sleeve (13) for receiving the pipe (2) and at least one sealing member (5) to provide a seal between the sleeve (13) and the pipe (2), a pressure member (6) for applying a pressure to the sleeve (13) and to the pipe (2), and a grip element (4) extending along at least a part of the perimeter of the pipe (2), wherein the grip element (4) is provided with dents (9) pressed out of the plane of the grip element (4) adjacent to slit like openings (8) punched out of the grip element (4), wherein edges (8′) of the slit like openings (8) are subjected to a peening operation.

### CROSS-REFERENCE TO RELATED APPLICATION

This application claims the benefit and priority of Dutch Application No. N2019920, filed Nov. 16, 2017. The entire disclosure of the above application is incorporated herein by reference.

### FIELD OF THE INVENTION

The invention relates to a coupling device for a pipe, comprising a sleeve for receiving the pipe and at least one sealing member to provide a seal between the sleeve and the pipe, and a pressure member for applying a pressure to the sleeve and to the pipe.

### BACKGROUND OF THE INVENTION

A relatively recent example of such a coupling device is disclosed in the international patent application WO2015/177259 assigned to the present applicant. Other examples are WO2007/055576, WO2010/114366 and WO2014/090667, all in the name of the applicant.

The applicant is a leading firm in this field which is exemplified by prior art for the instant invention which is embodied in the 1998 invention of EP 0 974 780, which discloses a coupling device for a pipe according to the preamble, wherein a grip element is provided with dents pressed out of the plane of the grip element adjacent to slit like openings that are punched out of the grip element. The instant invention also relates to a method for fabricating a grip element to be used in such a coupling device, and relates to said grip element.

With the previous technology of EP 0 974 780 it was found that improved tensile strain resistance was possible with a diversity of pipes, to note hard pipes like pipes of cast iron, steel, and stainless steel. At the same time the prior art coupling device was suitably used with more softer pipes as well, such as pipes of PVC, polyethylene and asbestos cement.

Over time practice showed however that although the results of applying the device of EP 0 974 780 were quite satisfactory, problems could occur when the coupling device was used on hard pipes that were provided with a covering layer, such as cast iron pipes provided with a protective epoxy layer or a zinc layer. With such pipes the tensile strain resistance could be less than desirable.

Another tensile strain resistance problem with the coupling device of the prior art could occur when the coupling device was applied with softer pipes. The dents of the device according to EP 0 974 780 could bite in such softer type of pipes in a way that the grip element of the coupling device would act as a cheese slicer on the surface of the pipe, due to which process the coupling device would gradually lose grip on the pipe. The applicant has earlier tried a solution for this problem as disclosed in EP 1 138 999, but there is still room for improvement.

The instant invention aims to provide a solution or at least alleviate one or more of the above-mentioned problems, and to this end a coupling device, a method of manufacturing a grip element, and such a grip element are proposed according to the specification.

### SUMMARY OF THE INVENTION

In a first aspect of the invention a coupling device is proposed which comprises a grip element extending along at least a part of the perimeter of the pipe, wherein the grip element is provided with dents pressed out of the plane of the grip element adjacent to slit like openings punched out of the grip element, and which comprises the novel feature that edges of the slit like openings are subjected to a peening operation. This brings about the advantage to modify the crystal structure of the metal that is used for the grip element, including the structure of the dents that are pressed out of the plane of the grip element. The dents will accordingly be harder which improves their effectiveness. Alternatively it is possible to reduce costs by applying cheaper base material from which the grip element is manufactured, without sacrificing the hardness of the dents. Another advantage is that with cheaper base material the coupling device of the invention endures for a longer time without maintenance or replacement.

A suitable and preferable way to subject the edges of the slit like openings to the peening operation is to execute this operation prior to pressing the dents out of the plane of the grip element. This can be done with an appropriate peening tool.

A feature that contributes to improving the effectiveness of the dents is that a frontal surface of a top of each dent is at an angle of approximately 90° with reference to the plane of the grip element.

The invention is also embodied in a method for fabricating the grip element to be used in a coupling device according to the invention, wherein slit like openings are punched in a plate, and wherein in a forming process dents are pressed out of the plane of the plate adjacent to the openings.

According to the invention prior to pressing the dents out of the plane of the plate, edges of the slit like openings are first subjected to a peening operation.

Correspondingly the invention is also embodied in a grip element provided with dents pressed out of the plane of the grip element adjacent to slit like openings punched out of the grip element, wherein the slit like openings are subjected to a peening treatment. In an advantageous embodiment peening of the edges of the slit like openings is executed prior to pressing the dents out of the plane of the grip element.

In another aspect of the invention which can be applied independent from the aforesaid features or in combination therewith, each grip element is supported by at least one pressure member, which pressure member is provided with protrusions that mate with the back of the dents that are pressed out of the plane of the corresponding grip element that is mounted on such pressure member.

The protrusions mating with the back of the dents that are pressed out of the plane of the grip element is an effective means to counteract the earlier mentioned cheese slicer effect when the coupling device is used on softer pipes. This counteracting effect is particularly promoted in an embodiment wherein the protrusions of the pressure member block openings in the grip element that are present next to the dents. The construction of the protrusions that mate with the back of the dents also provides that forces acting on the grip element elements due to strains exerted by the pipe on the coupling device, will effectively be transferred to the pressure members and absorbed by the construction of the coupling device.

The invention will hereinafter be further elucidated with reference to the drawing of an exemplary embodiment of a coupling device, a grip element and a method of manufacturing a grip element according to the invention that is not limiting as to the appended claims.

### BRIEF DESCRIPTION OF THE DRAWINGS

Embodiments of the invention will now be described, by way of example, and with reference to the accompanying drawings, in which:

FIG. 1 shows a cross-sectional side view of the coupling device according to the invention;

FIGS. 2A and 2B show respectively and schematically two process steps according to the prior art for manufacturing a dent in a grip element, and FIG. 2C shows a cross-sectional side view of a part of a grip element near the dent manufactured according to the prior art;

FIGS. 3A, 3B, and 3C show respectively and schematically three process steps according to the invention for manufacturing a dent in a grip element, and FIG. 3D shows a cross-sectional side view of a part of a grip element near the dent manufactured according to the invention;

FIGS. 4A and 4B show in cross-sectional side view and exploded view, respectively a grip element together with a pressure member of the coupling device of the invention.

### DESCRIPTION OF THE PREFERRED EMBODIMENTS

Whenever in the figures the same reference numerals are applied, these numerals refer to the same parts.

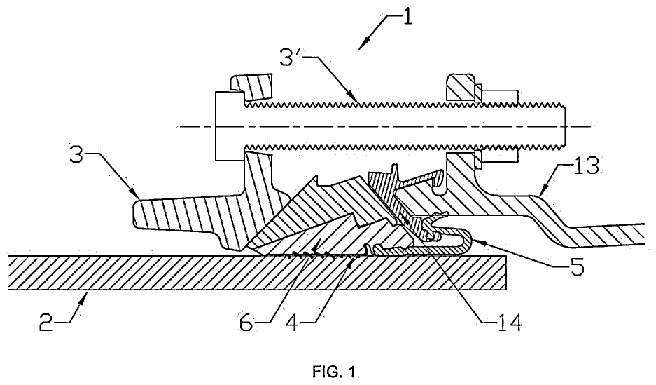

FIG. 1 shows a coupling device 1 of the invention in a cross-sectional side view. The coupling device 1 comprises a sleeve 13 for receiving a pipe 2 and at least one sealing member 5 to provide a seal between the sleeve 13 and the pipe 2. The sealing member 5 may be attached to the sleeve 13 with a clip 14. Further the coupling device 1 comprises a pressure member 6 for applying a pressure to the sleeve 13 and to the pipe 2. Actuation means 3, 3′ are provided to arrange that a pressure is applied to the pressure member 6, wherein a grip element 4 which extends along at least a part of the perimeter of the pipe 2 is supported by the pressure member 6. In this manner the grip element 4 is arranged to press on the pipe 2. As will be elucidated further hereinafter the grip element 4 is formed with dents pressed out of the plane of the grip element.

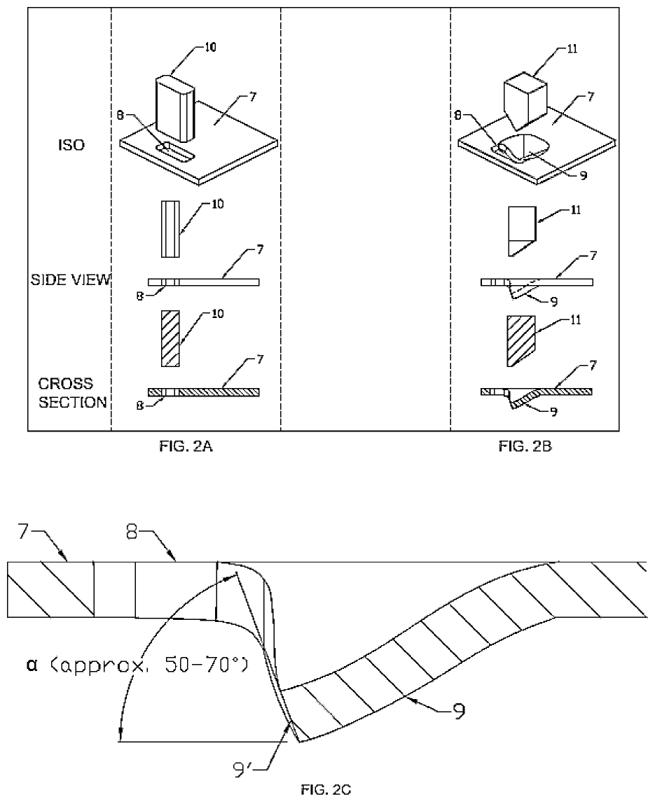

In FIGS. 2A and 2B a prior art method is elucidated for fabricating a grip element to be used in a coupling device as shown in FIG. 1. In this method a punching tool 10 is used to provide slit like openings 8 in a plate 7. This is shown in FIG. 2A from top to bottom in an isometric view, in a side view, and in a cross-sectional view. Similarly FIG. 2B shows that in a subsequent step a pressing tool 11 is used to press dents 9 out of the plane of the plate 7 adjacent to the openings 8.

FIG. 2C shows on larger scale one of the resulting dents 9 which is pressed out of the plane of the plate 7. In this prior art process a frontal surface 9′ of the top of the dent 9 is at an angle of between 50° and 70° with reference to the plane of the plate 7 that eventually forms the grip element.

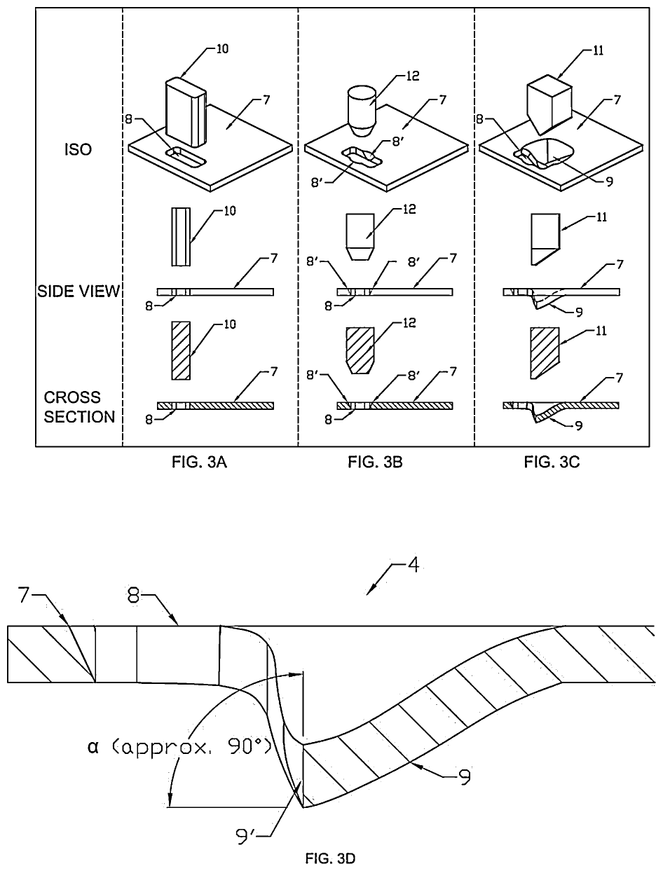

Correspondingly FIGS. 3A-3C show the method of the invention for fabricating a grip element 4 to be used in a coupling device as shown in FIG. 1.

In the method of the invention first a punching tool 10 is used to provide slit like openings 8 in a plate 7 as shown in FIG. 3A from top to bottom in an isometric view, in a side view, and in a cross-sectional view. Similarly FIG. 2B shows that in a subsequent step edges 8′ of the slit like openings 8 are subjected to an operation with a peening tool 12. FIG. 2C shows that thereafter in a further process when the peening of the edges 8′ of the slit like openings 8 is complete, a pressing tool 11 is used to press dents 9 out of the plane of the plate 7 adjacent to the openings 8 to form the eventual grip element 4.

FIG. 2D provides a detailed view on one of the resulting dents 9 which is pressed out of the plane of the plate 7. A frontal surface 9′ of the top of the dent 9 is at an angle of approximately 90° with reference to the plane of the plate 7 of the grip element 4.

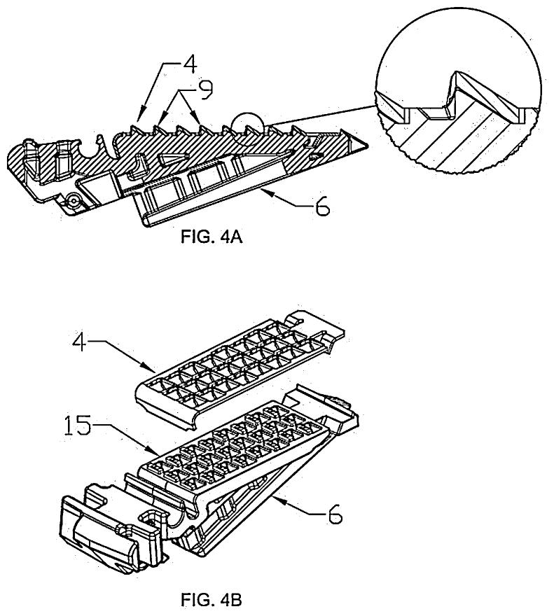

Turning now to FIG. 4A and FIG. 4B another aspect of the invention is elucidated. FIG. 4B shows separately in an isometric view a grip element 4 manufactured from a plate 7 as elucidated with reference to FIGS. 3A-3D, and a single pressure member 6. A multitude of such pressure members 6 together form a ring around the perimeter of the pipe 2 in the coupling device 1 which is referred to in FIG. 1. In FIG. 4A a single pressure member 6 is shown in a cross-sectional view, wherein a single grip element 4 is mounted on the pressure member 6. It is however also possible that the pressure member 6 supports a number of grip elements, or that a number of pressure members support a single grip element.

In the complete coupling device as shown in FIG. 1 preferably each single pressure member 6 supports a single grip element 4. Accordingly the pressure members 6 together support all grip elements 4 that collectively surround the pipe 2 shown in FIG. 1. In the mounted condition the grip elements 4 thus extend along the entire perimeter of the pipe 2 which is connected to the coupling device 1.

It is clearly shown in both FIG. 4A and FIG. 4B that the shown pressure member 6 is provided with multiple protrusions 15 at the side facing the grip element 4. These protrusions 15 are designed to mate with the back of the dents 9 that are pressed out of the plane of the grip element 4, preferably in a manner that when the grip element 4 is mounted on the pressure member 6 as shown in FIG. 4A, the protrusions 15 of the pressure member 6 block openings 8 in the grip element 4 that are present next to the dents 9. This construction also provides that forces acting on the grip element 4 due to strains exerted by the pipe 2 on the coupling device 1, will effectively be transferred to the pressure member 6 and absorbed by the construction of the coupling device.

Although the invention has been discussed in the foregoing with reference to an exemplary embodiment of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

19. A coupling device (1) for a pipe (2), comprising a sleeve (13) for receiving the pipe (2) and at least one sealing member (5) to provide a seal between the sleeve (13) and the pipe (2), a pressure member (6) for applying a pressure to the sleeve (13) and to the pipe (2), and a grip element (4) extending along at least a part of the perimeter of the pipe (2), wherein the grip element (4) is provided slit like openings (8) punched out of the grip element (4), the grip element (4) also being provided with dents (9) pressed out of a plane of the grip element (4) adjacent to the slit like openings (8) wherein edges (8′) of the slit like openings (8) having been subjected to a peening operation.

20. A coupling device according to claim 19, wherein the peening operation of the edges (8′) of the slit like openings (8) is executed prior to pressing the dents (9) out of the plane of the grip element (4).

21. A coupling device according to claim 19, wherein a frontal surface (9′) of a top of each dent (9) is at an angle of approximately 90° with reference to the plane of the grip element (4).

22. A coupling device according to claim 19, wherein the device comprises multiple grip elements (4), each grip element (4) being supported by at least one pressure member (6), which pressure member (6) is provided with protrusions (15) that mate with the back of the dents (9) that are pressed out of the plane of the grip element (4).

23. A coupling device according to claim 22, wherein the protrusions (15) of the pressure member (6) block openings (8) in the grip element (4) that are present next to the dents (9).

24. A method for fabricating a grip element (4) to be used in a coupling device (1) for a pipe (2), wherein slit like openings (8) are punched in a plate (7) and that in a forming process dents (9) are pressed out of the plane of the plate (7) adjacent to the openings (8), wherein prior to pressing the dents (9) out of the plane of the plate (7) edges (8′) of the slit like openings (8) are subjected to a peening operation.

25. A grip element (4) provided with dents (9) pressed out of the plane of the grip element (4) adjacent to slit like openings (8) punched out of the grip element (4), wherein edges (8′) of the slit like openings (8) are subjected to a peening operation.

26. A grip element (4) according to claim 25, wherein the peening operation of the edges (8′) of the slit like openings (8) is executed prior to pressing the dents (9) out of the plane of the grip element (4).

27. A grip element (4) according to claim 26, wherein a frontal surface (9′) of a top of the dent (9) is at an angle of approximately 90° with reference to the plane of the grip element (4).
